(19) United States
(12) Patent Application Publication
(10) Pub. No.: US 2019/0188630 A1
(43) Pub. Date: Jun. 20, 2019

(54) SYSTEM AND METHOD OF ORDER PROCESSING WITH SMART COOL-DOWN

(71) Applicants: Beijing Jingdong Shangke Information Technology Co., Ltd., Beijing (CN); JD.com American Technologies Corporation, Santa Clara, CA (US)

(72) Inventors: Di Wu, San Jose, CA (US); Xiantie Peng, Beijing (CN); Zhuo Feng, Beijing (CN); Shihong Lin, Beijing (CN); Yan Jin, Beijing (CN); Jie Zhu, Beijing (CN)

(21) Appl. No.: 15/848,601

(22) Filed: Dec. 20, 2017

(51) Int. Cl. G06Q 10/08; G06Q 10/06; G06N 99/00; G06N 5/04

(52) U.S. Cl. CPC G06Q 10/087; G06N 5/045; G06N 99/005; G06Q 10/06313

(57) ABSTRACT

An order processing system includes a computing device, which includes a processor and a storage device storing computer executable code. The computer executable code, when executed at the processor, is configured to: receive an order, determine a cool-down period of the order based on a cost function, and dispatch the order to a warehouse platform when the cool-down period expires. The cost function takes into account at least a waste cost due to process by the warehouse platform according to the order in case of possible cancellation of the order after the cool-down period and a delay cost due to delayed dispatching of the order to the warehouse platform by the cool-down period. The cool-down period is determined as one that minimizes the cost function in a prescribed range.

### FIELD OF THE INVENTION

The present disclosure relates generally to warehousing and logistics, and more particularly to systems and methods of order processing with smart cool-down.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In a general logistic system, orders made by customers will be passed to a warehouse platform for immediate fulfillment in order to satisfy delivery timeline. Some systems allow customers to cancel their orders during the fulfillment process to provide better customer experience. This, however, may cause additional wastes in the fulfillment process. For example, items that have been picked up from warehouse shelves need to be stowed back and packing materials may no longer be re-used.

Therefore, an unaddressed need exists in the art to address the aforementioned deficiencies and inadequacies.

### SUMMARY OF THE INVENTION

In one aspect, the disclosure is directed to an order processing system. In certain embodiments, the order processing system includes a computing device, which includes a processor and a storage device storing computer executable code. The computer executable code, when executed at the processor, is configured to:

receive an order;

determine a cool-down period of the order based on a cost function; and

dispatch the order to a warehouse platform when the cool-down period expires,

wherein the cost function takes into account at least a waste cost due to process by the warehouse platform according to the order in case of possible cancellation of the order after the cool-down period and a delay cost due to delayed dispatching of the order to the warehouse platform by the cool-down period; and

wherein the cool-down period is determined as one that minimizes the cost function in a prescribed range.

In another aspect, the present disclosure relates to a method of processing an order. The method includes:

determine a cool-down period of the order based on a cost function; and

dispatching the order to a warehouse platform when the cool-down period expires,

wherein the cost function takes into account at least a waste cost due to process by the warehouse platform according to the order in case of possible cancellation of the order after the cool-down period and a delay cost due to delayed dispatching of the order to the warehouse platform by the cool-down period, and

wherein the cool-down period is determined as one that minimizes the cost function in a prescribed range.

In another aspect, the present disclosure relates to non-transitory computer readable medium storing computer executable code. The computer executable code, when executed at a processor, is configured to:

receive an order;

determine a cool-down period of the order based on a cost function; and

dispatch the order to a warehouse platform when the cool-down period expires,

wherein the cost function takes into account at least a waste cost due to process by the warehouse platform according to the order in case of possible cancellation of the order after the cool-down period and a delay cost due to delayed dispatching of the order to the warehouse platform by the cool-down period; and

wherein the cool-down period is determined as one that minimizes the cost function in a prescribed range.

In certain embodiments, the cost function is established based on historical information relevant to historical orders within a specific period. In certain embodiments, the cost function is established by machine learning.

In certain embodiments, the cost function is α·P_{cancel}·Y(t)+F(t), α·P_{cancel}. Y(t) denotes the waste cost as per time t, and F(t) denotes the delay cost as per time t. Here, α denotes a coefficient, P_{cancel} denotes a cancellation probability of the order estimated based on information relevant to the order, and Y(t) denotes a conditional probability, estimated based on the historical information, that an order will be cancelled after the time t given that the order will be cancelled.

In certain embodiments, the delay cost is F(t)=β·t, wherein β denotes a coefficient. In certain embodiments, Y(t)=γ·exp(−λ·t), wherein γ and λ are parameters based on the historical information.

In certain embodiments, P_{cancel} is estimated based on the information relevant to the order according to a machine learning model, wherein the machine learning model establishes a relationship between a cancellation probability of a given order and information relevant to this given order based on the historical information. In certain embodiments, the machine learning model includes a logistic regression model or a decision tree based model. In certain embodiments, the decision tree based model includes a random forecast decision tree model or a gradient boost decision tree model.

In certain embodiments, the information relevant to the order includes order information, user information for a user who makes the order, product information for product(s) included in the order, promotion information for promotion used in the order, or user behavior information for the user.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, wherein:

FIG. 1 schematically depicts a system according to certain embodiments of the present disclosure.

FIG. 2 schematically depicts a method of processing an order according to certain embodiments of the present disclosure.

FIG. 3 schematically depicts machine learning according to certain embodiments of the present disclosure.

FIG. 4 schematically depicts a cost function according to certain embodiments of the present disclosure.

FIG. 5 schematically depicts a method of processing an order according to certain embodiments of the present disclosure.

FIG. 6 schematically depicts a computing device according to certain embodiments of the present disclosure.

### DETAILED DESCRIPTION OF THE INVENTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

In one aspect, the present disclosure is directed to an order processing system that provides an adaptive cool-down period. An order made by a user is held during the cool-down period, and then dispatched to a warehouse platform for fulfillment when the cool-down period expires. In certain embodiments, the cool-down period is adapted or optimized to the user, so that cost caused by possible cancellation of the order and/or by the delayed dispatching of the order can be reduced or even minimized.

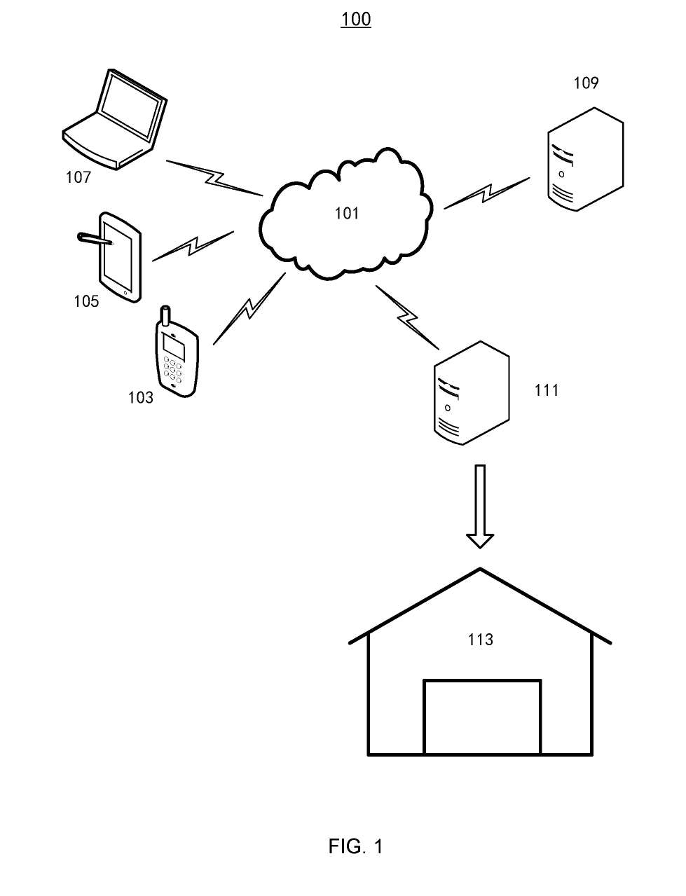

FIG. 1 schematically depicts a system according to certain embodiments of the present disclosure. As shown in FIG. 1, the system 100 includes a network 101, terminal devices 103, 105, 107 and servers 109, 111 which are interconnected via the network 101, and a warehouse platform 113.

The network 101 is a media to provide communication links between, e.g., the terminal devices 103, 105, 107 and the servers 109, 111. In some embodiments, the network 101 may include wired or wireless communication links, fiber, cable, or the like. In some embodiments, the network 101 may include at least one of Internet, Local Area Network (LAN), Wide Area Network (WAN), or cellular telecommunications network.

The terminal devices 103, 105, 107 may be used by their respective users to interact with each other, and/or with the servers 109, 111, to, for example, receive/send information therefrom/thereto. In certain embodiments, at least some of the terminal devices 103, 105, 107 may have various applications (APPs), such as, on-line shopping APP, web browser APP, search engine APP, Instant Messenger (IM) App, e-mail APP, and social networking APP, installed thereon. In some embodiments, the terminal devices 103, 105, 107 may include electronic devices having an Input/Output (I/O) device. The I/O device may include an input device such as keyboard or keypad, an output device such as a display or a speaker, and/or an integrated input and output device such as a touch screen. Such electronic devices may include, but not limited to, a smart phone, a tablet computer, a laptop computer, or a desktop computer.

The servers 109, 111 are servers to provide various services. In certain embodiments, the servers 109, 111 may include a backend server supporting logistics or e-commerce, e.g., on-line shopping by the terminal devices 103, 105, 107. In certain embodiments, the servers 109, 111 may be implemented by the distributed technique, the cloud technique, or the like. Therefore, at least one of the servers 109, 111 is not limited to the illustrated single one integrated entity, but may include interconnected entities (for example, computing platforms, storage devices, or the like) which cooperate with each other to perform some functions, for example, those functions to be described hereinafter.

In certain embodiments, the system 100 may include a logistic system or an e-commerce system. Various users may use their respective terminal devices 103, 105, 107 to browse items and/or search for specific items. Also, the system may recommend some items to the users. If the user finds one or more desired items, then he or she may make an order for those items.

For convenience of explanation, it is assumed here that the server 109 supports order related services, such as item presenting and order making, and that the server 111 supports order fulfillment related services, such as management of packaging and delivery. However, it is to be understood that the disclosed technology is not limited thereto. In certain embodiments, the servers 109 and 111 may merge. In certain embodiments, there may be multiple servers, at least some of which cooperate to provide the order related services, at least some of which cooperate to provide the order fulfillment related services, or at least some of which provide both (at least a part of) the order related services and (at least a part of) the order fulfillment related services.

The warehouse platform 113 is configured for fulfillment of the orders. In certain embodiments, the warehouse platform 113 includes one or more warehouses where items available for on-line shopping are stored. In certain embodiments, the warehouse platform 113 may be an automatic warehouse platform, where the order is automatically processed. For example, in certain embodiments, the warehouse platform 113 includes a logistics system, configured to deliver some items ordered by a user from the warehouse(s) to this user. In certain embodiments, the order fulfillment related server 111 may coordinate operations of the warehouse platform 113. In certain embodiments, the order fulfillment related server 111 may be incorporated into the warehouse platform 113, for example, as a control layer of the warehouse platform 113. Alternatively, the warehouse platform 113 may also be human-managed, where the order is processed manually by human workers.

When a user (indicated as user A), for example, the user of the terminal device 103, makes an order for some specific item(s) (indicated as item A) with his terminal 103, the terminal 103 (or more specifically, the order accepting user interface of the APP or application software at the terminal 103) may generate corresponding information about the order and then send the information of the order to the order related server 109 via the network 101. Thus, the order related server 109 receives this order and then passes this order to the order fulfillment related server 111. The order fulfillment related server 111 then instructs the warehouse platform 113 to pick up the ordered item A from shelve(s) in the warehouse(s), packaging the picked item into one or more packages, and then deliver the packages to the user A.

In certain embodiments, the logistic system or the e-commerce system allows the user to cancel his order. For example, the user A might cancel his order for the item A after he made the order, because, for example, he finds a cheaper price for the same item A. In case of order cancellation, there will be some wastes, because some processes might have been conducted according to the order, for example, the item A might have already been picked up and packaged. Thus, cost related to picking and packaging will be wasted.

To reduce such waste caused by possible order cancellation, a feasible way is to set a “cool-down” period. This cool-down period is provided to make the user cool down, reconsider his order, and possibly cancel some order that is not what he really desires. The order-related server 109 does not pass the order to the order fulfillment related server 111 immediately upon the order is made, but holds the order during the cool-down period and passes the order to the order fulfillment related server 111 for order fulfillment when the cool-down expires. It is apparent that the order, even if cancelled within the cool-down period, will cause substantially no actions of the warehouse platform 113, avoiding possible waste of the picking and packaging cost. In this regard, the cool-down period should be relatively long. This is because the longer is the cool-down period, the lower is the probability of order cancellation and thus the lower is the waste caused by the possible cancellation.

On the other hand, the cool-down period should not be too long, because the cool-down period will impact the efficiency of the order fulfillment. To improve user experience, the logistic system or the e-commerce system generally promises a very limited time period for the order fulfillment, for example, one day or even several hours. This means that the item A should be delivered to the user A within only the promised one day or several hours after he made the order. It is a challenging work for the warehouse platform 113. The cool-down period makes this work even more urgent. More specifically, the cool-down period might result in rush picking, packaging, and delivering, which will cause additional rush fee. Or even worse, the cool-down period might cause violation of the promised fulfillment period, which will cause violation penalty.

The order-related server 109 is configured to determine a smart cool-down period for an incoming order. In certain embodiments, the cool-down period is determined based on information relevant to the order, so that the cool-down period is adapted to the specific order, to reduce or even avoid waste caused by possible cancellation of this order. In determining the cool-down period, a cost function is evaluated. The cost function takes, into account, at least the above described two aspects, more specifically, a waste cost due to process by the warehouse platform according to the order in case of possible cancellation of the order after the cool-down period and a delay cost due to delayed dispatching of the order to the warehouse platform by the cool-down period. The cool-down period is determined as one that minimizes the cost function in a prescribed range. The cost function will be described in more detail later.

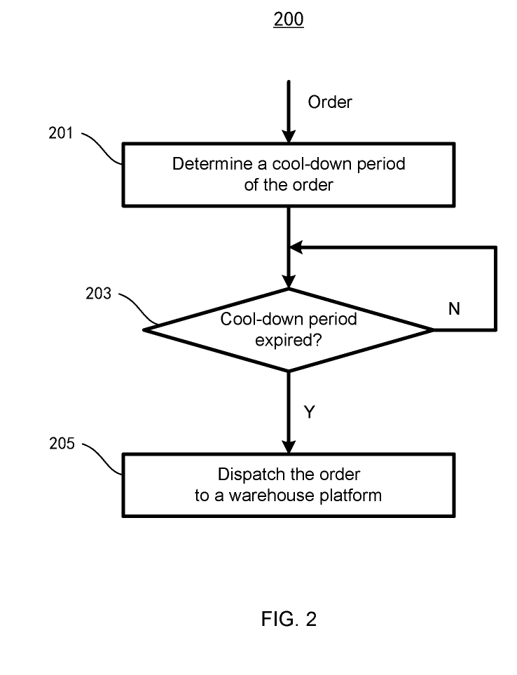

In certain embodiments, the order-related server 109 is configured to process the incoming order by running a computer executable code, stored therein or somewhere else, e.g., cloud. FIG. 2 schematically shows a flow executable by the order-relates server 109.

As shown in FIG. 2, for an incoming order, a cool-down period of the order is determined at operation 201. The cool-down period is determined based on the cost function as described above. At operation 203, it is judged whether the cool-down period expires or not (from receiving the incoming order). If the cool-down period expires, the order is dispatched or passed to the warehouse platform at operation 205 for fulfillment of the order, e.g., picking up item(s) included in the order, packaging the picked item(s) into one or more packages, and delivering the packages to a user who makes the order. If the cool-down period does not expire, then the order is held, waiting for expiration of the cool-down period.

Hereinafter, the cost function will be explained in more detail.

In certain embodiments, the cost function, including the waste cost and the delay cost, is established based on historical information relevant to historical orders within a specific period (for example, four weeks). This can be done by machine learning. In certain embodiments, the historical information is observed and also corresponding order fulfillment is observed. Specifically, for an order which is fulfilled without being canceled, the cost should be 0 (zero); while for an order which is canceled before being fulfilled, relevant cost is evaluated by, for example, counting cost of picking, packaging, and delivering that have already occurred. From observations of massive pieces of the historical information within the specific period, a cost model can be established by machine learning to map information relevant to an order with possible cost of the order. For a newly incoming order, information relevant to the incoming order may be observed, and then mapped to a cost based on the established cost model. For example, an incoming order, whose relevant information is similar to or even identical with that of some historical order(s), has a similar or even the same cost as that of the historical order(s). The cost model can be updated over time, based on the most recent historical information.

Information relevant to an order or order relevant information includes various pieces of information relevant to the order. In certain embodiments, the information relevant to the order comprises at least some of order information, user information for a user who makes the order, product information for product(s) included in the order, promotion information for promotion used in the order, or user behavior information for the user. In certain embodiments, the order information includes at least some of order time, order value, order product, promotion associated with the order, payment method and payment time, shipping and service charges, service level, order platform (such as, PC, mobile site, APP), or the like. In certain embodiments, the user information includes at least some of user membership level, historical purchases of the user, historical activities of the user, user profile information (such as profession, education, age, gender, interest of the user), or the like. In certain embodiments, the product information includes at least some of product category, produce price, product review, or the like. In certain embodiments, the promotion information includes at least some of promotion type, promotion equivalent discount, promotion placement, or the like. In certain embodiments, the user behavior information includes at least some of search and browse history, add-to-cart history, or the like.

More specifically, the cost function includes at least two aspects, the waste cost and the delay cost (and possibly other cost) as described above. The longer is the cool-down period, the lower is the waste cost. In other words, the waste cost is generally a decreasing function with respect to the cool-down period. In contrast, the longer is the cool-down period, the greater is the delay cost. In other words, the delay cost is generally an increasing function with respect to the cool-down period. Thus, the cost function includes at least two items, a decreasing one, i.e., the waste cost, and an increasing one, i.e., the delay cost.

The decreasing item, i.e., the waste cost, is dependent on an order cancellation probability P_{cancel}. The higher is the order cancellation probability, the higher is the waste cost. Further, the decreasing item, i.e., the waste cost, is also dependent on order cancellation time. If an order is cancelled before the cool-down period t expires, then there will be substantially no waste cost for the order; or otherwise, if an order is cancelled after the cool-down period t expires, then there will be the waste cost for the order. In other words, the decreasing item, i.e., the waste cost, is dependent on a conditional probability Y(t) that an order will be cancelled after the cool-down period t given that the order will be cancelled. Therefore, the decreasing item, i.e., the waste cost, is proportional to P_{cancel}·Y(t), and thus can be written as:

α·P_{cancel}·Y(t),

wherein, α is a coefficient to convert the probability to cost. The coefficient α may be a constant.

The coefficient α can be determined empirically, or from the historical information by, for example, machine leaning. In certain embodiments, cancelled historical orders and their associated cost due to the cancellation are observed to determine the coefficient α.

The order cancellation probability P_{cancel} can be estimated based on the information relevant to the order according to an estimation model. In certain embodiments, such an estimation model is established by machine learning from the historic information, and thus can be termed as a machine learning model. The model establishes a relationship between a cancellation probability of a given order and information relevant to this given order. In certain embodiments, the model includes a logistic regression model or a decision tree based mode such as a random forecast decision tree mode or a gradient boost decision tree model.

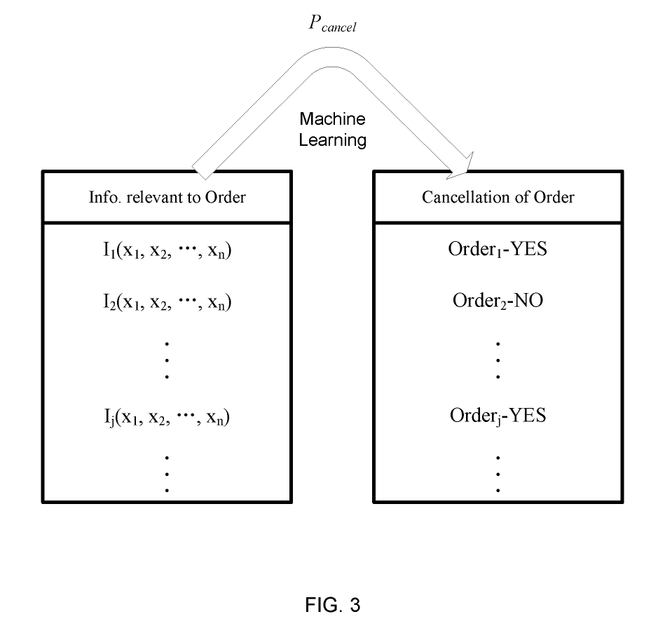

In certain embodiments, as shown in FIG. 3, information Iⱼ(x₁, x₂, . . . , xₙ) of an orderⱼ and also whether or not the orderⱼ is canceled or not are observed. From the observation, a group of orders having similar or identical relevant information can be found, and also how many orders in this group are canceled can be determined. For an order having similar or identical relevant information as the group, its cancellation probability can be determined as, for example, the number of the cancelled orders in this group divided by the number of all the orders in this group.

Here, x₁, x₂, . . . , xₙ denotes the various pieces of information, for example, those as described above. It is illustrated that each orderⱼ has the same number (here, n) of pieces of relevant information. In practice, some orders may have some of those pieces of relevant information unidentified. In this case, the unidentified pieces of relevant information may be given default values, or kept null.

The conditional probability Y(t) can be estimated based on the historical information by, for example, machine learning. Generally, an order has a less probability to be canceled over time. That is, the conditional probability Y(t) can be a decreasing function with respect to time t. In certain embodiments, the decreasing function may have an exponential form. In this case, the conditional probability Y(t) is written as:

Y(t)=γ·exp(−λ·t),

wherein γ and λ are parameters based on the historical information. The parameters γ and λ may be constants.

The parameters γ and λ can be determined empirically, or from the historical information by, for example, machine leaning from the historic information. In certain embodiments, cancelled orders and also cancellation time of those orders are observed. The probability Y(t) may be estimated by dividing the number of cancelled orders after time t by the number of all the cancelled orders. An exponential curve may be fitted based on the estimated probability Y(t) and the time t. The parameters γ and λ can be determined from the fitted exponential curve.

The increasing item, i.e., the delay cost, is dependent on time. The longer is the cool-down period t, the less time is left for the warehouse platform for order fulfillment and thus the higher is the delay cost. In certain embodiments, the delay cost is assumed as a linear function of the cool-down period t:

F(t)=β·t,

wherein β denotes a coefficient. The coefficient β may be a constant.

The coefficient β can be determined empirically, or from the historical information by, for example, machine leaning. In certain embodiments, additional costs caused by a reduced fulfillment period (the promised fulfillment period−the cool-down period t) may be evaluated based on the historical information, as compared to a normal fulfillment process that should be conducted in the entire promised fulfillment period. A straight line may be fitted based on the evaluated additional costs and the corresponding cool-down period t. The coefficient β can be determined as a slope of the fitted line.

In certain embodiments, the coefficients α and β are determined cooperatively. The coefficient α can be relatively great to give more weight to the waste cost. This is effective in a case where the promised fulfillment period is relatively long, for example. On the other hand, the coefficient β can be relatively great to give more weight to the delay cost. This is effective in a case where the promised fulfillment period is relatively short, for example. In certain embodiments, the system have different levels of services, e.g., time-sensitive service (with a promised fulfillment period of, for example, several hours) and normal service (with a promised fulfillment period of, for example, several days or one week), which can have different combinations of the coefficients α and β.

Therefore, in certain embodiments the cost function is:

α·P_{cancel}·Y(t)+F(t), or α·P_{cancel}·exp(−λ·t)+β·t.

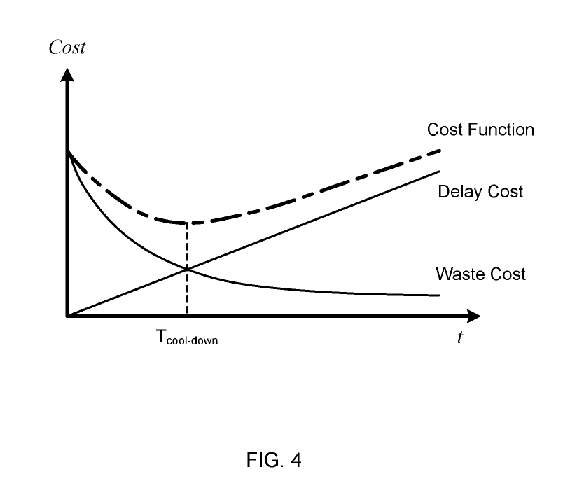

FIG. 4 schematically shows an example of the cost function. As shown in FIG. 4, the waste cost is a decreasing function with respect to time t, in an exponential form in this example, and the delay cost is an increasing function with respect to time t, in a linear form in this example. The cost function, as a sum of the waste cost and the delay cost, has a minimum. In certain embodiments, the cool-down period is determined as one that minimizes the cost function. Specifically, the cool-down period is a solution of the following problem:

$${min}_{t} α \cdot {P}_{cancel} \cdot Y ( t ) + F ( t )$$

subject to 0<t<T. Here, T denotes the promised fulfillment period minus necessary processing duration (including picking, packaging, and delivering). The solution is:

$$t = \{ \begin{matrix}0 , & if \frac{1}{λ} \cdot ln ( \frac{α \cdot λ \cdot {P}_{cancel}}{β} ) \leq 0 \\ \frac{1}{λ} \cdot ln ( \frac{α \cdot λ \cdot {P}_{cancel}}{β} ) , & if 0 < \frac{1}{λ} \cdot ln ( \frac{α \cdot λ \cdot {P}_{cancel}}{β} ) < T \\ T , & if \frac{1}{λ} \cdot ln ( \frac{α \cdot λ \cdot {P}_{cancel}}{β} ) \geq T\end{matrix}$$

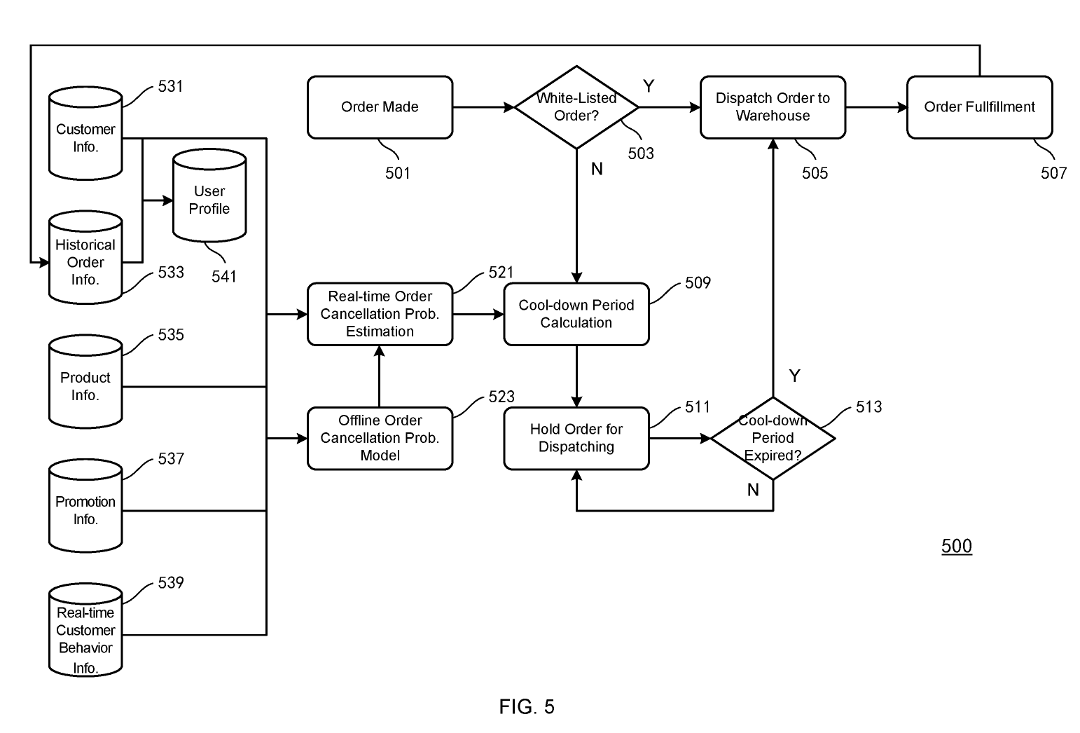

FIG. 5 schematically depicts a method of processing an order according to another embodiment.

As shown in FIG. 5, at operation 501, a user makes an order for his desired item(s). At operation 503, it is judged whether the order satisfies specific criteria to bypass the cool-down process. For example, if the user has a relatively higher membership level, such as a VIP membership, then the order can bypass the cool-down process. For another example, if the user has no cancellation history, then the order can bypass the cool-down process. If it is determined that the order should bypass the cool-down process, then at operation 505, the order is dispatched to the warehouse platform for immediate fulfillment at operation 507. Otherwise, if it is determined that the order is not exempt from the cool-down process, information relevant to the order is passed to a cool-down period calculation module (embodied, for example, by the server 109). At operation 509, the cool-down period calculation module calculates a cool-down period based on the information relevant according to a cost function, for example the one as described above. As described above, the cool-down period can be determined to reduce or even minimize the total expected cost due to possible cancellation. At operation 511, the order is held during the calculated cool-down period. For example, the order is sidelined in the order process pipeline. If cancellation of the order occurs during the cool-down period, the order will be automatically cancelled and removed from the order fulfillment process. At operation 513, it is judged whether the cool-down period expires or not. If it is judged that the cool-down period does not expire, the order is still being held. Otherwise, if it is judged that the cool-down period expires, the order is dispatched to the warehouse platform for fulfillment.

As described above, in calculating the cool-down period, the order cancellation probability is estimated. The order cancellation probability is estimated based on the information relevant to the current order at operation 521. Further, in estimating the order cancellation probability, a machine learning model is utilized. The machine learning model is established based on the historical information by off-line training at operation 523.

The order relevant information is stored in various databases, for example, customer information database 531, (historical) order information database 533, product information database 535, promotion information database 537, and real-time customer behavior information database 539.

In certain embodiments, as compared to an implementation of static holding time, the proposed technology can reduce about 35% of holding time while catching the same number of cancelled orders or can reduce cancellation-after-dispatch by 12% with the same total order holding time.

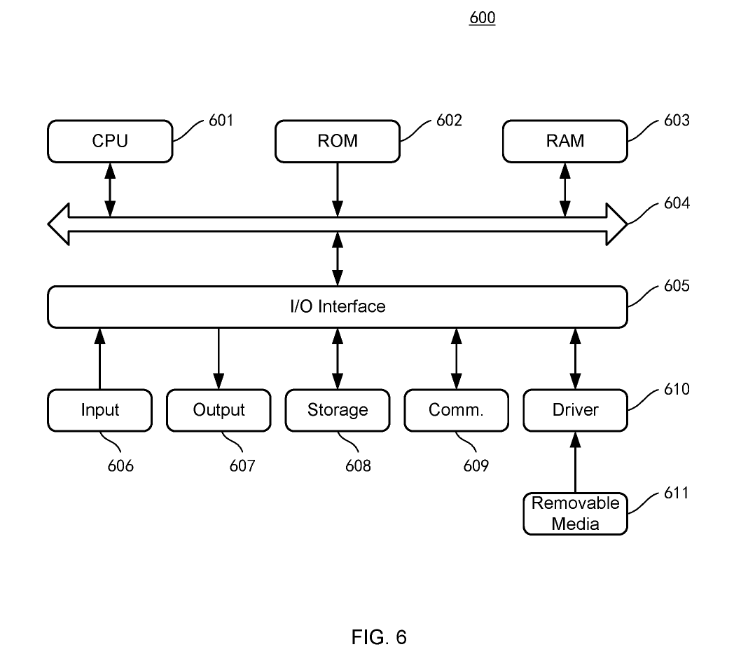

FIG. 6 schematically depicts a computing device according to certain embodiments of the present disclosure. In certain embodiments, the computing device 600 as shown in FIG. 6 may be used as one or more of the servers 109 and 111 as shown in FIG. 1.

As shown in FIG. 6, the computing device 600 includes a Central Processing Unit (CPU) 601. The CPU 601 is configured to perform various actions and processes according to programs stored in a Read Only Memory (ROM) 602 or loaded into a Random Access Memory (RAM) 603 from storage 608. The RAM 603 has various programs and data necessary for operations of the computing device 600. The CPU 601, the ROM 602, and the RAM 603 are interconnected with each other via a bus 604. Further, an I/O interface 605 is connected to the bus 604.

In certain embodiments, the computing device 600 further includes at least one or more of an input device 606 such as keyboard or mouse, an output device 607 such as Liquid Crystal Display (LCD), Light Emitting Diode (LED), Organic Light Emitting Diode (OLED) or speaker, the storage 608 such as Hard Disk Drive (HDD), and a communication interface 609 such as LAN card or modem, connected to the I/O interface 605. The communication interface 609 performs communication through a network such as Internet. In certain embodiments, a driver 610 is also connected to the I/O interface 605. A removable media 611, such as HDD, optical disk or semiconductor memory, may be mounted on the driver 610, so that programs stored thereon can be installed into the storage 608.

In certain embodiments, the process flow described herein may be implemented in software. Such software may be downloaded from the network via the communication interface 609 or read from the removable media 611, and then installed in the computing device. The computing device 600 will execute the process flow when running the software.

In a further aspect, the present disclosure is related to a non-transitory computer readable medium storing computer executable code. The code, when executed at one or more processer of the system, may perform the method as described above. In certain embodiments, the non-transitory computer readable medium may include, but not limited to, any physical or virtual storage media.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. An order processing system, the system comprising a computing device, the computing device comprising a processor and a storage device storing computer executable code, wherein the computer executable code, when executed at the processor, is configured to:
receive an order;
determine a cool-down period of the order based on a cost function; and
dispatch the order to a warehouse platform when the cool-down period expires,
wherein the cost function takes into account at least a waste cost due to process by the warehouse platform according to the order in case of possible cancellation of the order after the cool-down period and a delay cost due to delayed dispatching of the order to the warehouse platform by the cool-down period; and
wherein the cool-down period is determined as one that minimizes the cost function in a prescribed range.

2. The order processing system of claim 1, wherein the computer executable code, when executed at the processor, is further configured to establish the cost function based on historical information relevant to historical orders within a specific period.

3. The order processing system of claim 2, wherein the computer executable code, when executed at the processor, is configured to establish the cost function by machine learning.

4. The order processing system of claim 2, wherein the cost function is:
αP_{cancel}·Y(t)+F(t),
wherein α·P_{cancel}·Y(t) denotes the waste cost as per time t, and F(t) denotes the delay cost as per time t; and
wherein α denotes a coefficient, P_{cancel} denotes a cancellation probability of the order estimated based on information relevant to the order, and Y(t) denotes a conditional probability, estimated based on the historical information, that an order will be cancelled after the time t given that the order will be cancelled.

5. The order processing system of claim 4, wherein the computer executable code, when executed at the processor, is configured to estimate the delay cost as F(t)=β·t, wherein β denotes a coefficient.

6. The order processing system of claim 4, wherein Y(t)=γ·exp(−λ·t), and wherein γ and λ are parameters based on the historical information.

7. The order processing system of claim 4, wherein P_{cancel} is estimated based on the information relevant to the order according to a machine learning model, wherein the machine learning model establishes a relationship between a cancellation probability of a given order and information relevant to this given order based on the historical information.

8. The order processing system of claim 7, wherein the machine learning model comprises a logistic regression model or a decision tree based model.

9. The order processing system of claim 8, wherein the decision tree based model comprises a random forecast decision tree model or a gradient boost decision tree model.

10. The order processing system of claim 4, wherein the information relevant to the order comprises order information, user information for a user who makes the order, product information for a product or products included in the order, promotion information for promotion used in the order, or user behavior information for the user.

11. A method of processing an order, comprising:
determining a cool-down period of the order based on a cost function; and
dispatching the order to a warehouse platform when the cool-down period expires,
wherein the cost function takes into account at least a waste cost due to process by the warehouse platform according to the order in case of possible cancellation of the order after the cool-down period and a delay cost due to delayed dispatching of the order to the warehouse platform by the cool-down period, and
wherein the cool-down period is determined as one that minimizes the cost function in a prescribed range.

12. The method of claim 11, further comprising establishing the cost function based on historical information relevant to historical orders within a specific period.

13. The method of claim 12, wherein the cost function is:
α·P_{cancel}·Y(t)+F(t),
wherein α·P_{cancel}·Y(t) denotes the waste cost as per time t, and F(t) denotes the delay cost as per time t, and
wherein α denotes a coefficient, P_{cancel} denotes a cancellation probability of the order estimated based on information relevant to the order, and Y(t) denotes a conditional probability, estimated based on the historical information, that an order will be cancelled after the time t given that the order will be cancelled.

14. The method of claim 13, wherein F(t)=β·t, wherein β denotes a constant coefficient.

15. The method of claim 13, wherein Y(t)=γ·exp(−λ·t), wherein γ and λ are parameters based on the historical information.

16. The method of claim 13, wherein P_{cancel} is estimated based on the information relevant to the order according to a machine learning model, wherein the machine learning model establishes a relationship between a cancellation probability of a given order and information relevant to this given order based on the historical information.

17. The method of claim 16, wherein the machine learning model comprises a logistic regression model or a decision tree based model.

18. The method of claim 13, wherein the information relevant to the order comprises order information, user information for a user who makes the order, product information for a product or products included in the order, promotion information for promotion used in the order, or user behavior information for the user.

19. A non-transitory computer readable medium storing computer executable code, wherein the computer executable code, when executed at a processor, is configured to:
receive an order;
determine a cool-down period of the order based on a cost function; and
dispatch the order to a warehouse platform when the cool-down period expires,
wherein the cost function takes into account at least a waste cost due to process by the warehouse platform according to the order in case of possible cancellation of the order after the cool-down period and a delay cost due to delayed dispatching of the order to the warehouse platform by the cool-down period; and
wherein the cool-down period is determined as one that minimizes the cost function in a prescribed range.

20. The non-transitory computer readable medium of claim 19, wherein the cost function is:
α·P_{cancel}·Y(t)+F(t),
wherein α·P_{cancel}·Y(t) denotes the waste cost as per time t, and F(t) denotes the delay cost as per time t, and
wherein α denotes a coefficient, P_{cancel} denotes a cancellation probability of the order estimated based on information relevant to the order, and Y(t) denotes a conditional probability, estimated based on the historical information, that an order will be cancelled after the time t given that the order will be cancelled.
